(19) United States
(12) Patent Application Publication
(10) Pub. No.: US 2026/0307212 A1
(43) Pub. Date: Oct. 8, 2026

(54) C-CLAMP GRIP PLIERS

(71) Applicant: WYVERN TOOLS CO., LTD., Taichung City (TW)

(72) Inventor: SHIN AN SHIH, Taichung City (TW)

(21) Appl. No.: 19/172,824

(22) Filed: Apr. 8, 2025

(51) Int. Cl. B25B 7/12; B25B 7/04

(52) U.S. Cl. CPC B25B 7/123; B25B 7/04

(57) ABSTRACT

C-clamp grip pliers include a first handle, a side wall of a support head portion of the first handle having a shaft hole; a shaft, passing through the shaft hole; a restraining jaw, having a mounting portion located at a distance from one side of the side wall and mounted on the shaft, a restraining jaw arm extending from the mounting portion and having a first clamping head; a movable jaw, having a movable jaw head portion at the other side of the side wall, a movable jaw arm extending from one end of the movable jaw head portion and having a second clamping head, a pivot portion pivoted to the support head portion and a first pivoting portion pivoted to the second handle disposed on the other end of the movable jaw head portion. The jaw opening of the C-clamp grip pliers is adjustable within the length range of the shaft, thereby enhancing the pliers'versatility for different sizes and shapes of workpieces.

### FIELD OF THE INVENTION

The present invention relates to C-clamp grip pliers, and more particularly, to C-clamp grip pliers capable of enhancing the pliers'versatility for different sizes and shapes of workpieces.

### BACKGROUND OF THE INVENTION

Conventional universal pliers, as described in the background of Taiwan Utility Model Publication No. No. M449066, comprise a fixed plier handle 11, a movable plier handle 12 that can be pivoted relative to the fixed plier handle 11 to be in an open state and a closed state, a toggle lever locking element 13 that is pivotally connected to the movable plier handle 12 and has a free end 131 extending to the fixed plier handle 11, and an adjustment screw 14 that corresponds to the toggle lever locking element 13 and is rotatably screwed on the fixed plier handle 11.

The fixed plier handle 11 includes a first handle 111 and a fixed jaw 112 connected to one end of the first handle 111. The movable plier handle 12 includes a second handle 121 that can be opened and closed relative to the first handle 111 and a movable jaw 122 that can be opened and closed relative to the fixed jaw 112 and is pivotally connected between one end of the second handle 121 and the fixed plier handle 11.

The adjustment screw 14 has a screw rod 141 and a cylindrical adjustment knob 142. The free end 131 of the toggle lever locking element 13 leans against the screw rod 141. The screw rod 141 is rotatably screwed to the first handle 111. The cylindrical adjustment knob 142 is connected to the outer end of the screw rod 141 opposite the toggle lever locking element 13. The outer end of the screw rod 141 extends out of the first handle 111.

When in use, the fixed plier handle 11 and the movable plier handle 12 are opened to position a workpiece 15 to be clamped between the fixed jaw 112 and the movable jaw 122, and then the user exerts a force on the first and second handles 111, 121, such that the workpiece 15 can be clamped securely. After that, the adjustment knob 142 of the adjustment screw 14 is rotated to increase the clamping force of the fixed jaw 112 and the movable jaw 122 on the workpiece 15, such that the workpiece 15 is clamped securely even when no continuous force is applied to the first and second handles 111, 121. This allows for the adjustment of the force exerted by the fixed jaw 112 and the movable jaw 122 on the clamped workpiece 15.

Although the fixed jaw 112 and the movable jaw 122 can be operated to clamp the workpiece 15 through the force applied to the first and second handles 111, 121, the size of the workpiece to be clamped by the foregoing conventional universal pliers is limited to the pivoting angle range between the movable jaw 122 and the fixed jaw 112, making it impossible to expand the jaw opening as desired for larger workpieces. The disclosure of the foregoing Taiwan Utility Model Publication No. M449066 or other conventional universal pliers, such as Taiwan Patent No. I411498 have the same jaw design. Due to the mechanism or condition that the movable jaw is pivoted to clamp a workpiece, the jaw opening is restricted to a certain range, making it impossible to expand the jaw opening to enhance the pliers'versatility for different sizes and shapes of workpieces.

### SUMMARY OF THE INVENTION

The primary object of the present invention is to provide C-clamp grip pliers, comprising a first handle, a shaft, a restraining jaw, a movable jaw, an elastic member, a second handle, a release lever, a connecting rod, and a screw rod.

The first handle includes a grip portion having a C-shaped cross-section. One end of the grip portion forms a support head portion, and the other end of the grip portion has a screw hole. One side of the support head portion has a side wall. The side wall has a shaft hole.

The shaft includes a shaft body having a cross section corresponding in shape to the shaft hole. The shaft passes through the shaft hole and is mounted on the support head portion. The axis of the shaft body is defined as a working centerline of the C-clamp grip pliers.

The restraining jaw is located at a distance from a first side of the side wall of the support head portion and disposed on the shaft. The restraining jaw includes a mounting portion, a restraining jaw arm, and a first clamping head. The mounting portion leans against one side of the shaft and is mounted on the shaft. The restraining jaw arm extends from one end of the mounting portion away from the shaft and is above the working centerline. The restraining jaw arm is ⊃-shaped. The first clamping head is disposed on one end of the restraining jaw arm.

The movable jaw is located at a second side of the side wall of the support head portion. The movable jaw includes a movable jaw head portion, a movable jaw arm, a pivot portion, a first pivoting portion, a second clamping head, and a pull portion. The movable jaw head portion faces the mounting portion of the restraining jaw and leans against the same side of the shaft as the mounting portion. The movable jaw arm extends from one end of the movable jaw head portion away from the shaft and is above the working centerline. The pivot portion and the first pivoting portion are disposed on two corners of the edge of another end of the movable jaw head portion and are below the working centerline. The pivot portion is pivotally connected to the support head portion. The first pivoting portion is located at a distance from the support head portion. The movable jaw arm is ⊃-shaped, corresponding to the restraining jaw arm. The second clamping head is disposed on one end of the movable jaw arm. The pull portion is disposed between the pivot portion and the first pivoting portion of the movable jaw head portion.

The elastic member has one end fixed to the grip portion and another end connected to the pull portion for pulling the movable jaw back after the movable jaw is pivoted.

The second handle includes a grasping portion, a first pivot pin, a second pivot pin, and a third pivot pin. The first pivot pin is disposed on one end of the grasping portion and pivotally connected to the first pivoting portion. The second pivot pin is disposed at a distance from a distal end of the grabbing portion. The third pivot pin is disposed between the first pivot pin and the second pivot pin.

The release lever has a middle portion pivotally connected to the second pivot pin. One end of the release lever forms a push portion, and the other end of the release lever forms a release operation portion.

The connecting rod has an arcuate protrusion relative to the push portion. One end of the connecting rod is pivotally connected to the third pivot pin, and the other end of the connecting rod extends to the grip portion and forms a stop portion.

The screw rod is screwed to the screw hole. One end of the screw rod is in contact with the stop portion on the grip portion, and the other end of the screw rod extends out of the screw hole and forms an operation knob.

In use, when the second clamping head of the C-clamp grip pliers is obstructed or restricted, the first handle and the second handle are moved to approach each other and gripped with force. At the beginning of exerting force, the first handle is first pivoted by an angle, which results in that the shaft hole holds the shaft so that the support head portion is secured on the shaft without sliding. Then, the second handle is pivoted about the first pivot pin. The movable jaw is pushed to pivot by the support of the connecting rod, so that the second clamping head of the movable jaw arm generates a clamping force toward the first clamping head.

When the C-clamp grip pliers are used to clamp a target workpiece, the shaft is adjusted to slide left and right on the support head portion of the first handle for the first clamping head and the second clamping head to come into contact with the target workpiece. When the second handle is moved toward the first handle and gripped with force, the target workpiece blocks the second clamping head, generating a reaction force to pivot the first handle by an angle. At the initial stage of gripping the second handle, the shaft hole holds the shaft so that the support head portion is secured on the shaft, thereby securing the position of the pivot section. The second handle is continuously gripped and operated to exert force. The second handle is supported by the connecting rod, allowing the first pivot pin to be slightly pivoted about the pivot portion, such that the second clamping head on the movable jaw arm can clamp the target workpiece under the condition that the restraining jaw arm and the first clamping head are fixed and immobile.

The overall structure of the C-clamp grip pliers allows for adjustment of the jaw opening between the first clamping head and the second clamping head within the length range of the shaft. This enables the C-clamp grip pliers to clamp large-sized target workpiece, thereby enhancing the pliers'versatility for different sizes and shapes of workpieces.

Preferably, the shaft hole in the support head portion of the first handle is an elongate hole. The shaft has a cross section corresponding in shape to the shaft hole. The shaft body is a flat ruler-shaped iron bar that passes through the shaft hole and is slidable freely. The shaft and the movable jaw head portion of the movable jaw form a large-area surface contact. Thus, when the movable jaw is pivoted, the pivotal action of the movable jaw head portion is confined or guided by the surface of the shaft to reduce shaking or deflection.

Preferably, at least one stopper is fixedly connected to the support head portion of the first handle and located close to the shaft above or below the working centerline. The at least one stopper assists the shaft hole in supporting the shaft 24, which not only increases the strength of the shaft hole against deformation but also reduce or avoid excessive tilting of both ends of the shaft passing through the shaft hole.

Preferably, the mounting portion of the restraining jaw is located at a distance from the first side of the side wall of the support head portion, opposite the movable jaw, and is fixed on the shaft. The mounting portion of the restraining jaw is fixed on the shaft so that the first clamping head is fixed and immovable relative to the shaft. The jaw opening of the C-clamp grip pliers can be adjusted by sliding the shaft left and right in the shaft hole of the support head portion.

Preferably, the mounting portion of the restraining jaw leans against one side of the shaft. The mounting portion has a bridging body. The bridging body has a receiving hole corresponding in shape to the cross section of the shaft. The shaft is inserted through the receiving hole so that the mounting portion is mounted on the shaft. When the first clamping head of the restraining jaw is blocked, the mounting portion slightly deflects by an angle, enabling the receiving hole to hold the shaft. This prevents the mounting portion from sliding toward the distal end and thus achieves a fixed effect. By sliding the mounting position of the mounting portion of the restraining jaw of the C-clamp grip pliers on the shaft, the jaw opening of the C-clamp grip pliers is adjustable. A support plate is formed on one end of the bridging body of the mounting portion. The support plate and the mounting portion together lean against two sides of the shaft. When the first clamping head is used to clamp the target workpiece, the shaft is supported by the support plate to reduce the deflection of the restraining jaw arm when it is subjected to force. The first clamping head is disposed on one end of the restraining jaw arm extending from one end of the mounting portion. The first clamping head is approximately T-shaped and has a first clamping surface. The first clamping head is pivotally connected to the end of the restraining jaw arm by a first pivot on one end of the first clamping head opposite the first clamping surface. The first clamping head is pivotable on the end of the restraining jaw arm. Even if the mounting portion is deflected to hold the shaft, the first clamping surface of the first clamping head can still be in contact with the target workpiece.

Preferably, the second clamping head is disposed on one end of the movable jaw arm. The second clamping head is approximately T-shaped and has a second clamping surface. The second clamping head is pivotally connected to the end of the movable jaw arm by a second pivot on one end of the second clamping head opposite the second clamping surface. The second clamping head is pivotable on the end of the movable jaw arm. When the movable jaw arm is pivoted toward the target workpiece, the second clamping surface of the second clamping head is naturally or automatically adjusted to be in contact with the target workpiece, transmitting the clamping force to act on the target workpiece.

Preferably, at least one end of the shaft body of the shaft is provided with a restricting member 241 extending radially beyond the surface of the shaft body. The restricting member cannot pass through the shaft hole, thereby restricting the shaft from being separated from the support head portion.

### BRIEF DESCRIPTION OF THE DRAWINGS

FIG. 1 is a planar view of the present invention;

FIG. 2 is a schematic view of the present invention, wherein the first and second handles are sectioned;

FIG. 3 is an enlarged view of circle A of FIG. 2;

FIG. 4 is an exploded view of the restraining paw of the present invention;

FIG. 5 is a side view of the first handle of the present invention;

FIG. 6 is a schematic view of the present invention when the second handle is operated;

FIG. 7 is an enlarged view of circle B of FIG. 6;

FIG. 8 is a schematic view of the present invention when in use, illustrating that the target workpiece is placed in the jaw opening;

FIG. 9 is a schematic view of the present invention when in use, illustrating that the second handle is operated after the target workpiece is placed in the jaw opening;

FIG. 10 is a schematic view of the present invention when in use, illustrating the state of the first handle during the operation of the second handle; and

FIG. 11 is a schematic view of the present invention when in use, illustrating the target workpiece is clamped by the C-clamp grip pliers.

### DETAILED DESCRIPTION OF THE PREFERRED EMBODIMENTS

Embodiments of the present invention will now be described, by way of example only, with reference to the accompanying drawings.

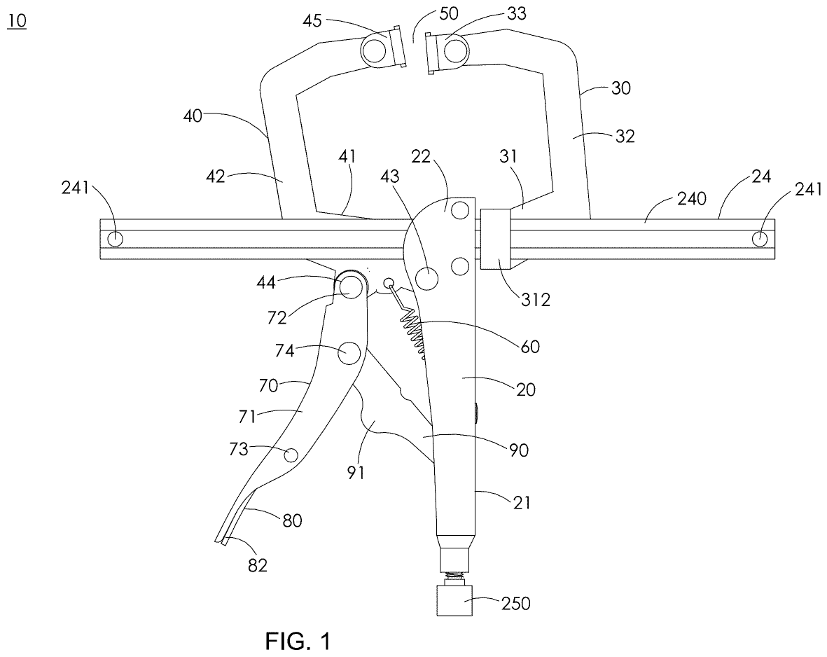

As shown in FIG. 1 through FIG. 5, C-clamp grip pliers 10 according to an embodiment of the present invention comprises a first handle 20, a shaft 24, a restraining jaw 30, a movable jaw 40, an elastic member 60, a second handle 70, a release lever 80, a connecting rod 90, and a screw rod 25.

The first handle 20 includes a grip portion 21 having a C-shaped cross-section. One end of the grip portion 21 forms a support head portion 22, and the other end of the grip portion 21 has a screw hole 23. One side of the support head portion 22 has a side wall 220. The side wall 220 has a shaft hole 221.

The shaft 24 includes a shaft body 240 having a cross section corresponding in shape to the shaft hole 221. The shaft 24 passes through the shaft hole 221 and is mounted on the support head portion 22. The axis of the shaft body 240 is defined as a working centerline CE of the C-clamp grip pliers 10.

The restraining jaw 30 is located at a distance from a first side of the side wall 220 of the support head portion 22 and disposed on the shaft 24. The restraining jaw 30 includes a mounting portion 31, a restraining jaw arm 32, and a first clamping head 33. The mounting portion 31 is in the form of a plate leaning against one side of the shaft 24 and mounted on the shaft 24. The restraining jaw arm 32 extends from one end of the mounting portion 31 away from the shaft 24 and is above the working centerline CE. The restraining jaw arm 32 is ⊃-shaped. The first clamping head 33 is disposed on one end of the restraining jaw arm 32.

The movable jaw 40 is located at a second side of the side wall 220 of the support head portion 22. The movable jaw 40 includes a movable jaw head portion 41, a movable jaw arm 42, a pivot portion 43, a first pivoting portion 44, a second clamping head 45, and a pull portion 46. The movable jaw head portion 41 faces the mounting portion 31 of the restraining jaw 30 and is in the form of a plate leaning against the same side of the shaft 24 as the mounting portion 31. The movable jaw arm 42 extends from one end of the movable jaw head portion 41 away from the shaft 24 and is above the working centerline CE. The pivot portion 43 and the first pivoting portion 44 are disposed on two corners of the edge of another end of the movable jaw head portion 41 and are below the working centerline CE. The pivot portion 43 is pivotally connected to the support head portion 22. The first pivoting portion 44 is located at a distance from the support head portion 22. The movable jaw arm 42 is ⊃-shaped, corresponding to the restraining jaw arm 32. The second clamping head 45 is disposed on one end of the movable jaw arm 42. The pull portion 46 is disposed between the pivot portion 43 and the first pivoting portion 44 of the movable jaw head portion 41.

Preferably, the elastic member 60 is a tension spring. One end of the elastic member 60 is fixed to the grip portion 21 and the other end of the elastic member 60 is connected to the pull portion 46 for pulling the movable jaw 40 back after the movable jaw 40 is pivoted.

The second handle 70 includes a grasping portion 71, a first pivot pin 72, a second pivot pin 73, and a third pivot pin 73. The first pivot pin 72 is disposed on one end of the grasping portion 71 and pivotally connected to the first pivoting portion 44. The second pivot pin 73 is disposed at a distance from a distal end of the grabbing portion 71. The third pivot pin 74 is disposed between the first pivot pin 72 and the second pivot pin 73.

The release lever 80 has a middle portion pivotally connected to the second pivot pin 73. One end of the release lever 80 forms a push portion 81, and the other end of the release lever 80 forms a release operation portion 82.

The connecting rod 90 has an arcuate protrusion 91 relative to the push portion 81. One end of the connecting rod 90 is pivotally connected to the third pivot pin 74, and the other end of the connecting rod 90 extends to the grip portion 21 and forms a stop portion 92.

The screw rod 25 is screwed to the screw hole 23. One end of the screw rod 25 is in contact with the stop portion 92 on the grip portion 21, and the other end of the screw rod 25 extends out of the screw hole 23 and forms an operation knob 250.

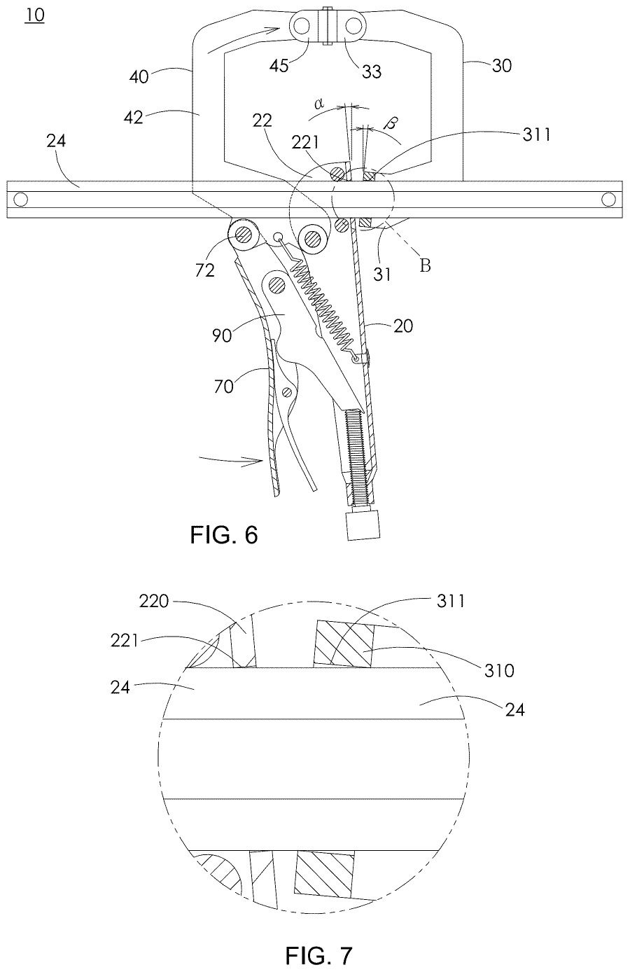

As shown in FIG. 6 and FIG. 7, in use, when the second clamping head 45 of the C-clamp grip pliers 10 is obstructed or restricted (e.g., when it comes into contact with the target workpiece to be clamped), the first handle 20 and the second handle 70 are moved to approach each other and gripped with force. At the beginning of exerting force, the first handle 20 is first pivoted by an angle α (the angle α, referring to FIG. 3 and FIG. 7, is determined or set by the thickness of the side wall 220 and the gap between the shaft hole 221 and the shaft 24, preferably, about 5 degrees), which results in that the shaft hole 221 holds the shaft 24 so that the support head portion 22 is secured on the shaft 24 without sliding. Then, the second handle 70 is pivoted about the first pivot pin 72. The movable jaw 40 is pushed to pivot by the resistive support of the connecting rod 90, so that the second clamping head 70 of the movable jaw arm 42 generates a clamping force toward the first clamping head 33.

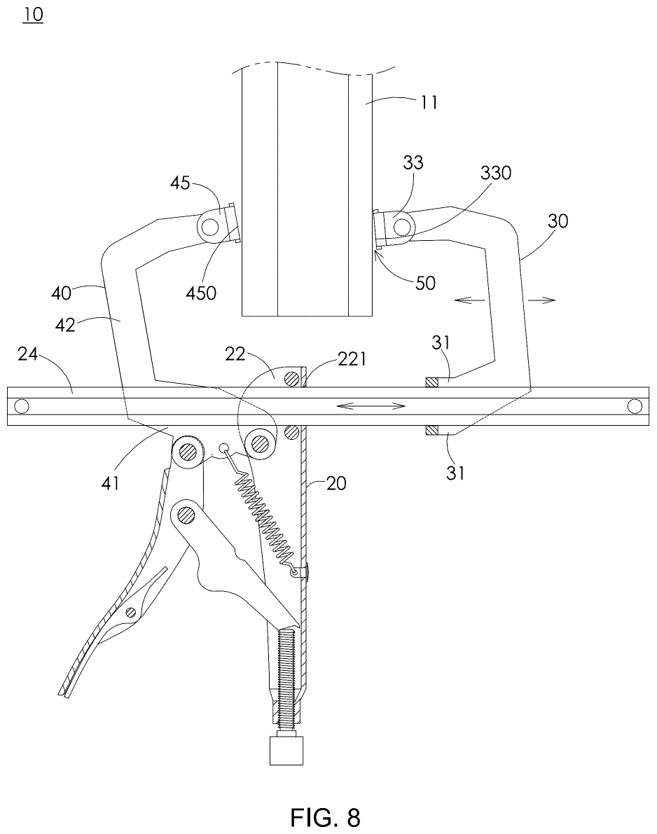

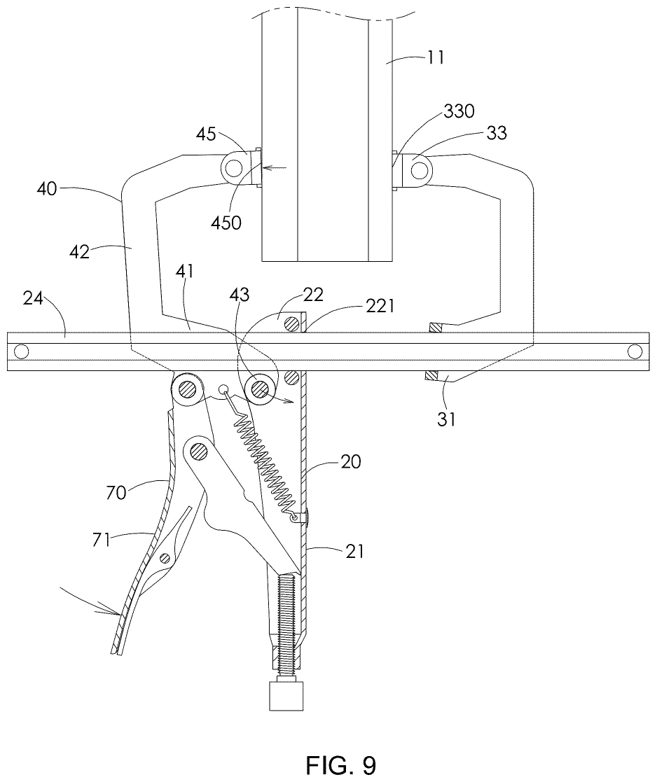

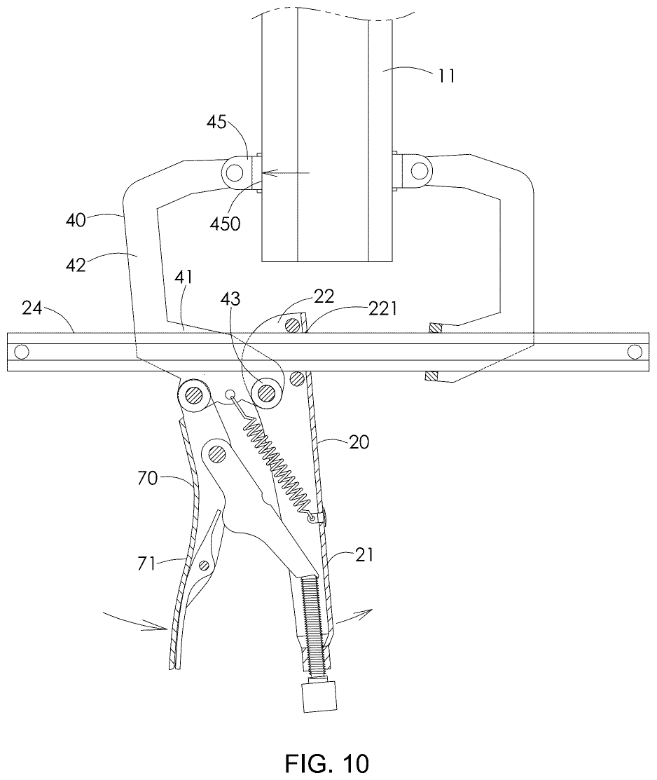

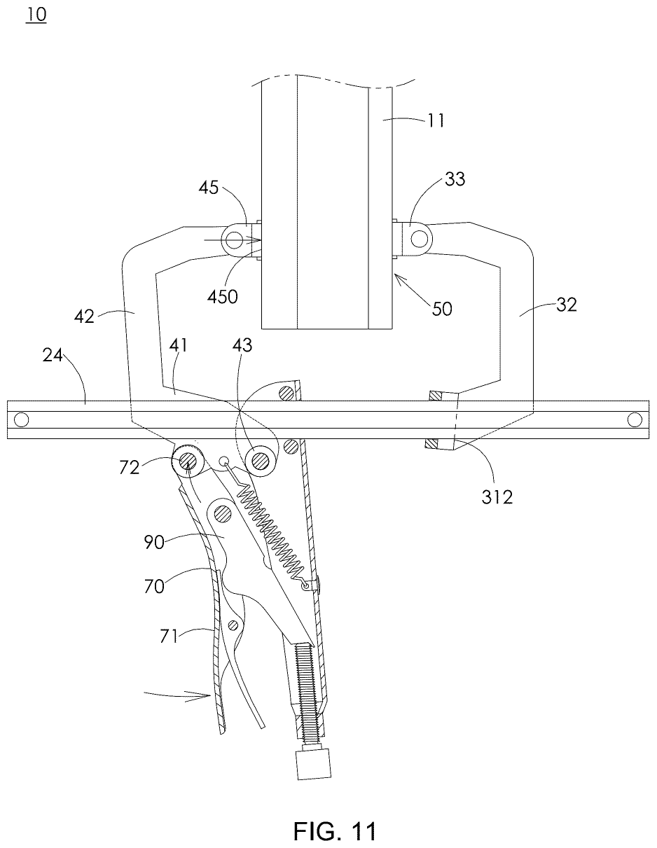

As shown in FIG. 8, when the C-clamp grip pliers 10 are used to clamp a target workpiece 11, the shaft 24 is adjusted to slide left and right on the support head portion 22 (i.e., the shaft hole 221) of the first handle 20, alternatively, the mounting portion 31 of the restraining jaw 30 is adjusted and positioned on the shaft 24, such that the first clamping head 33 and the second clamping head 45 are moved to approach or come into contact with the target workpiece 1. As shown in FIG. 9 and FIG. 10, when the second handle 70 is moved toward the first handle 20 for the grasping portion 71 to approach the grip portion 21 and gripped with force, the immobile target workpiece 11 blocks the second clamping head 45, generating a reaction force to pivot the first handle 20 by an angle α (referring to FIG. 6) . At the initial stage of gripping the second handle 70 (referring to FIG. 3 and FIG. 7), the shaft hole 221 holds the shaft 24 so that the support head portion 22 is secured on the shaft 24, thereby securing the position of the pivot section 43. As shown in FIG. 11, the second handle 70 (the grasping portion 71) is continuously gripped and operated to exert force. The second handle 70 is supported by the connecting rod 90, allowing the first pivot pin 72 to be slightly pivoted about the pivot portion 43, such that the second clamping head 45 on the movable jaw arm 42 can clamp the target workpiece 11 under the condition that the restraining jaw arm 32 and the first clamping head 33 are fixed and immobile.

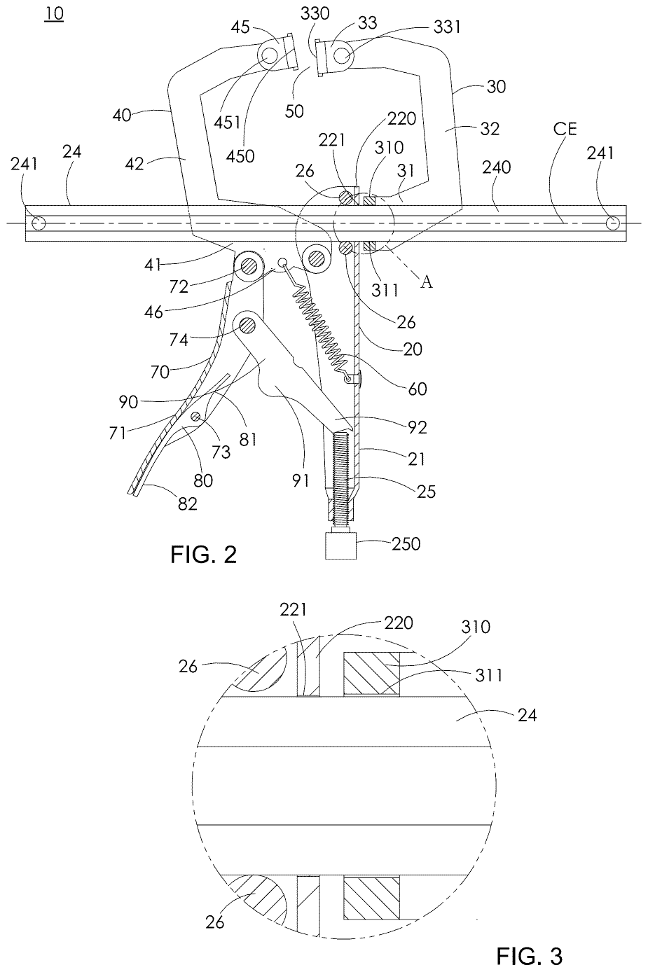

As shown in FIG. 2 and FIG. 11, the overall structure of the C-clamp grip pliers 10 allows for adjustment of the jaw opening 50 between the first clamping head 33 and the second clamping head 45 within the length range of the shaft 24. This enables the C-clamp grip pliers 10 to clamp a large-sized target workpiece 11, thereby enhancing the pliers'versatility for different sizes and shapes of workpieces.

According to the foregoing embodiment, preferably, as shown in FIG. 2 and FIG. 5, the shaft hole 221 in the support head portion 22 of the first handle 20 is an elongate hole. The cross section of the shaft 24 is shaped relative to the shaft hole 221. The shaft body 240 is a flat ruler-shaped iron bar that passes through the shaft hole 221 and is slidable freely. The shaft 24 and the movable jaw head portion 41 of the movable jaw 40 form a large-area surface contact. Thus, as shown in FIG. 8 through FIG. 11, when the movable jaw 40 is pivoted, the pivotal action of the movable jaw head portion 41 is confined or guided by the surface of the shaft 24 to reduce shaking or deflection.

According to the foregoing embodiment, preferably, as shown in FIG. 2, at least one stopper 26 is fixedly connected to the support head portion 22 of the first handle 20 and located close to the shaft 24 above or below the working centerline CE. Preferably, two stoppers 26 are fixedly connected to the support head portion 22 of the first handle 20 and located close to the shaft 24 above and below the working centerline CE. The at least one stopper 26 assists the shaft hole 221 in supporting the shaft 24, which not only increases the strength of the shaft hole 221 against deformation but also reduce or avoid excessive tilting of both ends of the shaft 24 passing through the shaft hole 221.

According to the foregoing embodiment, preferably, as shown in FIG. 2, the mounting portion 31 of the restraining jaw 30 is located at a distance from the first side of the side wall 220 of the support head portion 22, opposite the movable jaw 40, and is fixed on the shaft 24. (For example, the mounting portion 31 may be locked by a screw.) The mounting portion 31 of the restraining jaw 30 is fixed on the shaft 24 so that the first clamping head 33 (including the restraining jaw arm 32) is fixed and immovable relative to the shaft 24. The jaw opening 50 of the C-clamp grip pliers 10 can be adjusted by sliding the shaft 24 left and right (not shown) in the shaft hole 221 of the support head portion 22.

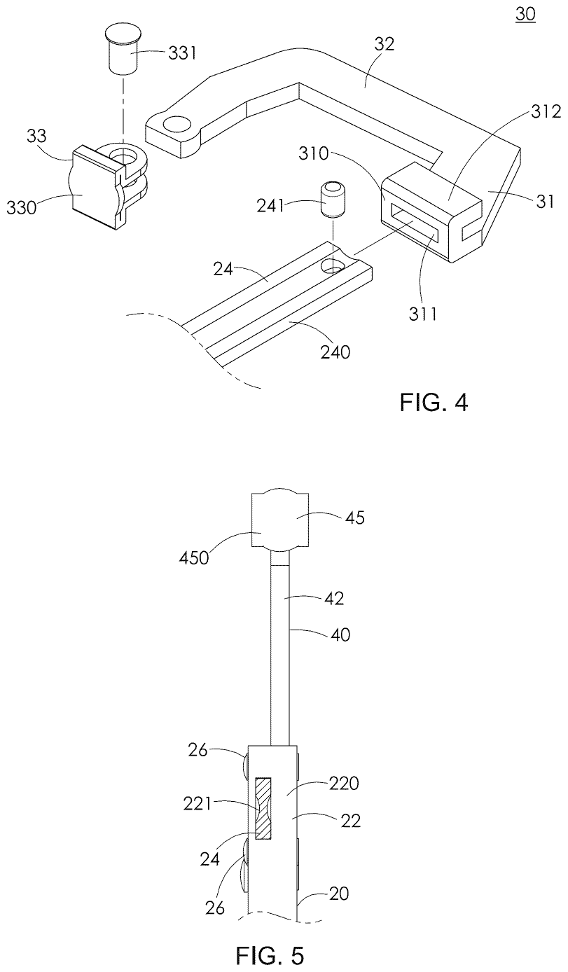

According to the foregoing embodiment, preferably, as shown in FIG. 2, FIG. 3 and FIG. 5, the mounting portion 31 of the restraining jaw 30 leans against one side of the shaft 24. The mounting portion 31 has a bridging body 310. The bridging body 310 has a receiving hole 311 corresponding in shape to the cross section of the shaft 24. The shaft 24 is inserted through the receiving hole 311 so that the mounting portion 31 is mounted on the shaft 24. As shown in FIG. 6 and FIG. 7, when the first clamping head 33 of the restraining jaw 30 is blocked, the mounting portion 31 slightly deflects by an angle β, enabling the receiving hole 311 to hold the shaft 24. This prevents the mounting portion 31 from sliding toward the distal end and thus achieves a fixed effect. As shown in FIG. 8, by sliding the mounting position of the mounting portion 31 of the restraining jaw 30 of the C-clamp grip pliers 10 on the shaft 24, the jaw opening 50 of the C-clamp grip pliers 10 is adjusted to match the target workpiece 11. As shown in FIG. 4, a support plate 312 is formed on one end of the bridging body 310 of the mounting portion 31. The support plate 312 and the mounting portion 31 together lean against two sides of the shaft 24. As shown in FIG. 1 and FIG. 11, when the first clamping head 33 is used to clamp the target workpiece 11, the shaft 24 is supported by the support plate 312 to reduce the deflection of the restraining jaw arm 32 when it is subjected to force. As shown in FIG. 2 and FIG. 4, the first clamping head 33 is disposed on one end of the restraining jaw arm 32 extending from one end of the mounting portion 31. The first clamping head 33 is approximately T-shaped and has a first clamping surface 330. The first clamping head 33 is pivotally connected to the end of the restraining jaw arm 32 by a first pivot 331 on one end of the first clamping head 33 opposite the first clamping surface 330. The first clamping head 33 is pivotable on the end of the restraining jaw arm 32. As shown in FIG. 8 and FIG. 9, even if the mounting portion 31 is deflected to hold the shaft 24, the first clamping surface 330 of the first clamping head 33 can still be in contact with the target workpiece 11.

According to the foregoing embodiment, preferably, as shown in FIG. 2, the second clamping head 45 is disposed on one end of the movable jaw arm 42. The second clamping head 45 (equivalent to the configuration of the first clamping head 33 in FIG. 4) is approximately T-shaped and has a second clamping surface 450. The second clamping head 45 is pivotally connected to the end of the movable jaw arm 42 by a second pivot 451 on one end of the second clamping head 45 opposite the second clamping surface 450. The second clamping head 45 is pivotable on the end of the movable jaw arm 42. As shown in FIG. 8 through FIG. 11, when the movable jaw arm 42 is pivoted toward the target workpiece 11, the second clamping surface 450 of the second clamping head 45 is naturally or automatically adjusted to be in contact with the target workpiece 11, firmly transmitting the clamping force to act on the target workpiece 11.

According to the foregoing embodiment, preferably, as shown in FIG. 2 and FIG. 4, at least one end (preferably, both ends) of the shaft body 240 of the shaft 24 is provided with a restricting member 241 (which may be a pin) extending radially beyond the surface of the shaft body 240. The restricting member 241 cannot pass through the shaft hole 221, thereby restricting the shaft 24 from being separated from the support head portion 22.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. C-clamp grip pliers, comprising:
a first handle, including a grip portion having a C-shaped cross-section, one end of the grip portion forming a support head portion, another end of the grip portion having a screw hole; one side of the support head portion having a side wall, the side wall having a shaft hole;
a shaft, including a shaft body having a cross section corresponding in shape to the shaft hole, the shaft passing through the shaft hole and being mounted on the support head portion, an axis of the shaft body being defined as a working centerline of the C-clamp grip pliers;
a restraining jaw, located at a distance from a first side of the side wall of the support head portion and disposed on the shaft, the restraining jaw including a mounting portion, a restraining jaw arm and a first clamping head, the mounting portion leaning against one side of the shaft and being mounted on the shaft, the restraining jaw arm extending from one end of the mounting portion away from the shaft and being above the working centerline, the restraining jaw arm being ⊃-shaped, the first clamping head being disposed on one end of the restraining jaw arm;
a movable jaw, located at a second side of the side wall of the support head portion, the movable jaw including a movable jaw head portion, a movable jaw arm, a pivot portion, a first pivoting portion, a second clamping head and a pull portion, the movable jaw head portion facing the mounting portion of the restraining jaw and leaning against the same side of the shaft as the mounting portion, the movable jaw arm extending from one end of the movable jaw head portion away from the shaft and being above the working centerline, the pivot portion and the first pivoting portion being disposed on two corners of an edge of another end of the movable jaw head portion and being below the working centerline, the pivot portion being pivotally connected to the support head portion, the first pivoting portion being located at a distance from the support head portion, the movable jaw arm being ⊃-shaped, corresponding to the restraining jaw arm, the second clamping head being disposed on one end of the movable jaw arm; the pull portion being disposed between the pivot portion and the first pivoting portion of the movable jaw head portion;
an elastic member, having one end fixed to the grip portion and another end connected to the pull portion for pulling the movable jaw back after the movable jaw is pivoted;
a second handle, including a grasping portion, a first pivot pin, a second pivot pin and a third pivot pin, the first pivot pin being disposed on one end of the grasping portion and pivotally connected to the first pivoting portion, the second pivot pin being disposed at a distance from a distal end of the grabbing portion, the third pivot pin being disposed between the first pivot pin and the second pivot pin;
a release lever, having a middle portion pivotally connected to the second pivot pin, one end of the release lever forming a push portion, another end of the release lever forming a release operation portion;
a connecting rod, having an arcuate protrusion relative to the push portion, one end of the connecting rod being pivotally connected to the third pivot pin, another end of the connecting rod extending to the grip portion and forming a stop portion;
a screw rod, screwed to the screw hole, one end of the screw rod being in contact with the stop portion on the grip portion, another end of the screw rod extending out of the screw hole and forming an operation knob.

2. The C-clamp grip pliers as claimed in claim 1, wherein the shaft hole in the support head portion of the first handle is an elongate hole, the shaft has a cross section corresponding in shape to the shaft hole, and the shaft body is a flat ruler-shaped iron bar that passes through the shaft hole and is slidable freely.

3. The C-clamp grip pliers as claimed in claim 1, wherein at least one stopper is fixedly connected to the support head portion of the first handle and located close to the shaft above or below the working centerline.

4. The C-clamp grip pliers as claimed in claim 1, wherein the mounting portion of the restraining jaw is located at a distance from the first side of the side wall of the support head portion, opposite the movable jaw, and is fixed on the shaft.

5. The C-clamp grip pliers as claimed in claim 1, wherein the mounting portion has a bridging body, the bridging body has a receiving hole corresponding in shape to a cross section of the shaft, and the shaft is inserted through the receiving hole so that the mounting portion is mounted on the shaft.

6. The C-clamp grip pliers as claimed in claim 5, wherein a support plate is formed on one end of the bridging body of the mounting portion.

7. The C-clamp grip pliers as claimed in claim 5, wherein the first clamping head is approximately T-shaped and has a first clamping surface, and the first clamping head is pivotally connected to the end of the restraining jaw arm by a first pivot on one end of the first clamping head opposite the first clamping surface.

8. The C-clamp grip pliers as claimed in claim 1, wherein the second clamping head is approximately T-shaped and has a second clamping surface, and the second clamping head is pivotally connected to the end of the movable jaw arm by a second pivot on one end of the second clamping head opposite the second clamping surface.

9. The C-clamp grip pliers as claimed in claim 1, wherein at least one end of the shaft body of the shaft is provided with a restricting member extending radially beyond a surface of the shaft body.
